(19) United States
(12) Patent Application Publication
(10) Pub. No.: US 2016/0185583 A1
(43) Pub. Date: Jun. 30, 2016

(54) BEVERAGE CAP OPENER TOOL

(71) Applicants: Michael ESPOSITO, North Caldwell, NJ (US); George MALEK, North Caldwell, NJ (US)

(72) Inventors: Michael ESPOSITO, North Caldwell, NJ (US); George MALEK, North Caldwell, NJ (US)

(21) Appl. No.: 14/806,790

(22) Filed: Jul. 23, 2015

Related U.S. Application Data
(60) Provisional application No. 62/028,025, filed on Jul. 23, 2014.

(51) Int. Cl. B67B 7/00

(52) U.S. Cl. CPC B67B 7/24

(57) ABSTRACT

A cap opener tool penetrates bottle caps and lids using an angled needle to access beverages or other liquid products. Liquid products inside the bottles can be consumed or accessed quickly through a cap hole formed in the cap by the angled needle of the cap opener tool. The tool includes a housing that fits over bottle caps, and the housing includes a base from which the angled needed extends or is attached. The angle of the walls of the angled needle form a corresponding angle in the bottle caps as the bottle cap is penetrated. The resulting cap hole provides access to the liquid products in the bottle. Liquid products can be forced outward through the cap hole by applying pressure to the bottle, such as by squeezing the bottle. By forcing the liquid products through the cap hole, the liquid products can be easily consumed or dispensed.

### CROSS-REFERENCE TO RELATED APPLICATIONS

This application claims the benefit of priority of U.S. Provisional Application No. 62/028,025 filed on Jul. 23, 2014. The entire contents of U.S. Provisional Application No. 67/028,025 filed on Jul. 23, 2014, are incorporated by reference.

### TECHNICAL FIELD

This technology relates to bottle opener tools and equipment. More particularly, the technology relates to systems, devices, and methods of opening bottle caps using an angled needle cap opener tool.

### BACKGROUND

There is a large segment of the population who enjoy bottled beverages, such as water, soda, and other soft drinks, on a regular basis throughout the day and at social occasions. Fruit flavored waters, sports drinks, and sodas are often served cold in plastic bottles. Bottled water is also served cold, at room temperature, or slightly chilled. Users often engage in active lifestyles and imbibe mass quantities of liquids, such as water, sports drinks, and the like.

Many individuals carry drink bottles that contain water or other potable beverages. These bottles are often formed from plastic and include a cap. Some conventional drink bottles include a threaded neck or other neck from which a user drinks fluid contained in the drink bottle after removal of the cap. Some conventional drink bottles include a spout, or nozzle, from which the drink fluid may be drawn from the drink bottle without removing the cap of the drink bottle. Conventional spouts include straws and rigid spouts having an outlet through which drink fluid may flow. Other conventional drink bottles require the cap to be removed to permit drink fluid to be removed from the drink bottle.

Many soft drink, water, and other liquid containing bottles are sold with tops or lids that must be removed to gain access to the liquid inside the bottles. Users either drink directly from these bottles and containers or pour the contents of the containers into another cup or glass. For adults, spilling is generally not a concern. For babies, toddlers, and small children who like drinking out of the container to emulate adult behavior, it is not uncommon to spill the liquid from the container due to unforeseen events, such as an accident or careless handling of the container. The large bottle opening after the cap has been removed can result in a mess or waste of product when the bottle or container is spilled or if the user knocks over their drink.

Some sports beverage bottles include tops that allow direct flow of the liquid from the bottle. While this approach is convenient when preparing to drink the beverage, it also has several disadvantages. One disadvantage is the cost associated with this particular style of cap, which is then discarded with the bottle. An additional disadvantage is that the caps cannot be used on all sizes and shapes of bottles. The manufacturer, merchant, and/or consumer must bear the cost in terms of time, effort, and expense in finding and purchasing the product in particular sizes with which the caps can be used.

Also, these bottles often include an additional foil or other sealed layer below the sports bottle cap that must be opened to access the liquid from within the bottle. That is, a user must remove the sports bottle cap, open the sealed foil layer, discard the sealed foil layer, and reinstall the sports bottle cap before the liquid can be dispensed. A problem associated with the foil or other sealed layer is that they typically require that a tool or device be inserted to break the seal and allow access to the liquid from the caps. This can be unsafe and undesirable, because the tool or device can contact the user and cause cuts or other harm.

Prior attempts to provide a convenient and safe method of accessing beverages from plastic bottles have not provided a satisfactory solution.

### SUMMARY

The claimed invention provides an integral point cap opener tool that penetrates bottle caps and lids using an angled needle. In some example embodiments, the angled needle can be conical in shape, frustoconical (i.e., a cone with the tip removed), or other variations where the base of the opener tool tapers to a vertex to puncture a bottle cap or lid. The angled needle penetrates plastic and other bottle caps to provide access to beverages or other liquid products in the bottles. Users can then dispense or consume the liquid products inside the bottles quickly through a cap hole formed in the cap or lid by the angled needle of the integral point cap opener tool. The angled walls of the angled needle forma corresponding angle in the cross-section of the bottle cap as the bottle cap is penetrated. The angled needle can be further offset with respect to the base/ceiling of the housing. That is, the angled needle can be an oblique cone with its vertex not over the center of its circular base and can point vertically downward at an angle other than 90 degrees from the base/ceiling of the housing. The resulting cap hole provides access to the liquid products in the bottle, while the angle prevents spillage of the liquid in the bottle. Liquid products can be accessed or dispensed by forcing them outward through the cap hole by applying pressure to the bottle, such as by squeezing the bottle or by inverting an upright bottle.

The cap opener tool can include an optional tab where a string, chain, ring, or other tether can be attached to make it easy to carry the opener tool. The housing of the tool can include ribs or other textured features to provide an easy grip surface with which a user can operate the integral point cap opener tool. Likewise, the tool can include an enlarged grip surface, such as a concentric handle area or an offset portion with which the user can operate the tool. The tool can be formed in non-circular shapes, such as ovals, hexagons, octagons, and the like, to facilitate use by children, the elderly, and those that may have difficulty with twist-off caps or other small devices.

Additionally, the sidewall of the integral point cap opener tool can be made with various thicknesses. For example, some embodiments can use a thicker sidewall to provide improved durability. Other embodiments of the opener tool can use a thinner sidewall such that the sidewall can be inserted between a pop top opener on a soda (or other) can and used as a fulcrum to open the pop top. The exact dimensions of the sidewalls can be modified based on the application. The thickness of the walls can be varied, as the opener tool can be used on a number of different bottle tops. For example, an integral point cap opener can be used on screw cap water bottle tops, aluminum cans with tab tops, scalloped metal beer bottles, soda, juice, water, and liquid tops, as well as other bottle tops that require a tool to open. The cap opener tool can also include other opening devices, such as bottle openers and the like.

In this fashion, a user can select a plastic bottle and place the integral point cap opener over the cap of the bottle with the angled needle against the top of the bottle cap. The user can then apply a force to the tool to puncture the plastic bottle cap with the angled needle. The angled needle provides an angled cut (cap hole) in the plastic bottle cap through which a beverage or liquid can flow. The angled cut in the beverage cap prevents spillage of the beverage through the cap hole. The cap opener tool in accordance with the claimed invention provides the user with easy access to the beverage without having to worry about a major mess or waste of product if the bottle is knocked over.

The cap opener tool provides a convenient and reusable method of opening plastic bottle tops prior to consuming the beverage or liquid. There would be no need for sports bottle caps as the opener tool opens plastic bottles without the need to disassemble a sports bottle, open a sealed foil layer, discard the sealed foil layer, and reinstall the sports bottle cap before the liquid can be dispensed. The opener tool of the claimed invention eliminates the chance for injury as no additional tools are needed to open a sealed foil layer, since the sealed foil layer can be eliminated.

The claimed invention provides users a safe and efficient manner of opening and consuming the beverage without waste or spillage. The claimed invention can include child-safe, travel-safe and environmentally-safe features.

The claimed invention provides an opener tool with a housing that fits over a plastic cap of a plastic bottle. The housing can have a base section that includes at least one angled needle. Multiple angled needles can be used in the tool. A user applies a force to the housing that causes the angled needle to puncture the plastic cap of the plastic bottle, resulting in an angled cut (cap hole) in the bottle cap. The beverage or liquid can be accessed through the cap hole, and the angle of the cap hole prevents spillage of the beverage or liquid if the plastic bottle is inadvertently upended or knocked over.

### BRIEF DESCRIPTION OF THE DRAWINGS

FIGS. 1A-1C show a bottom view, a side view, and a cross sectional view, respectively, of an opener tool in accordance with the claimed invention.

FIG. 1D shows a cross sectional view of an opener tool in accordance with the claimed invention with an oblique angled needle offset at a non-right angle with respect to the ceiling/base of the housing.

FIG. 2 is a top view of an example embodiment of the claimed invention, including a flat top surface that can be custom labeled.

FIG. 3 is a side view of an example embodiment of the claimed invention, including a tab where a chain is attached to carry the tool.

FIG. 4 is a bottom view of an example embodiment of an opener tool of the claimed invention, including a tab where a chain is attached to carry the tool.

FIG. 5 is a front perspective view of an example embodiment of an opener tool in accordance with the claimed invention shown in use on a plastic water bottle.

FIGS. 6A and 6B show example embodiments of an opener tool in accordance with the claimed invention in use tethered to backpacks using a chain and tab.

FIGS. 7A-7C show a bottom view, a side view, and across sectional view, respectively, of an example embodiment of an opener tool in accordance with the claimed invention.

FIG. 7D shows a cross sectional view of an example embodiment of an opener tool of the claimed invention with an oblique angled needle offset at an exemplary non-right angle with respect to the ceiling/base of the housing.

FIGS. 8-10 illustrate an example embodiment of a method of using an opener tool in accordance with the claimed invention to create a cap hole through which liquid in a bottle is accessed.

FIG. 11 illustrates an example embodiment of the claimed opener tool invention in use, where liquid in a bottle is accessed through a cap hole.

FIG. 12 shows a bottom cutaway view of an opener tool in accordance with the claimed invention with a screw thread as the angled needle.

FIGS. 13A-13D show a bottom view, a bottom perspective view, a side view, and a cross sectional view, respectively, of an opener tool in accordance with the claimed invention with a screw thread as the angled needle.

FIG. 14 shows an example bottom view of an opener tool of the claimed invention with a non-cylindrical housing.

FIG, 15 shows an example side view of an opener tool of the claimed invention that includes an integrated bottle opener.

### DETAILED DESCRIPTION

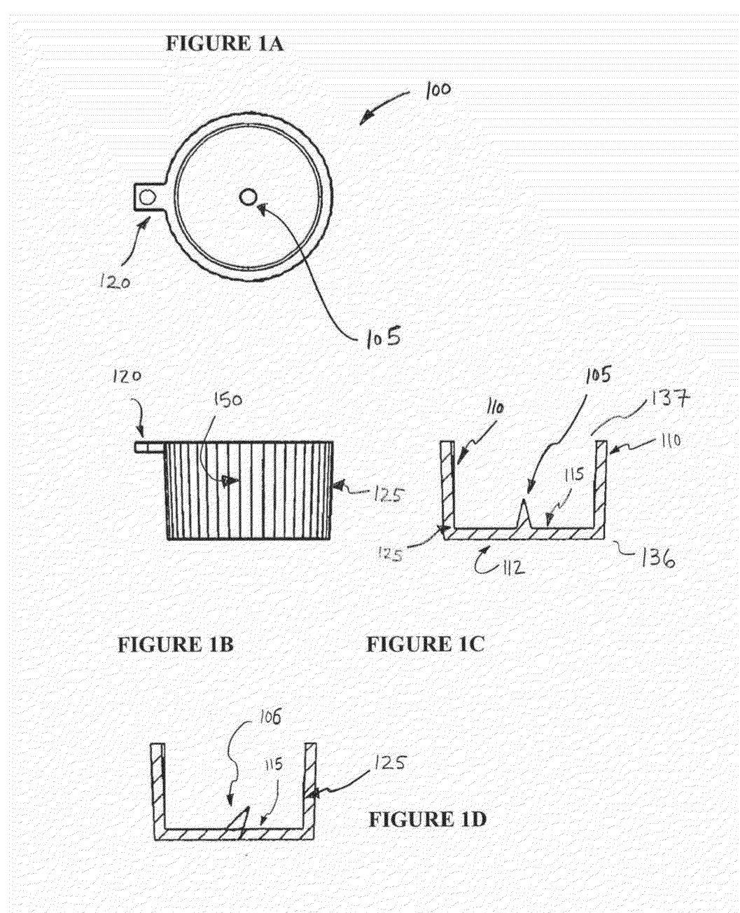

The claimed invention employs an angled needle in an opener tool to open various different bottle tops. In one example embodiment of the claimed invention shown in FIGS. 1A-1C, an integral point cap opener tool 100 includes a housing 125 that includes a sidewall 110, base 115 (also referred to as “ceiling” when the tool 100 is in its operating position), and top surface 112. Top surface 112 forms the top of the opener tool 100 when the opener tool 100 is in operation. The tool 100 penetrates bottle caps and lids using an angled needle 105 that extends from base/ceiling 115 vertically in the interior space of housing 125.

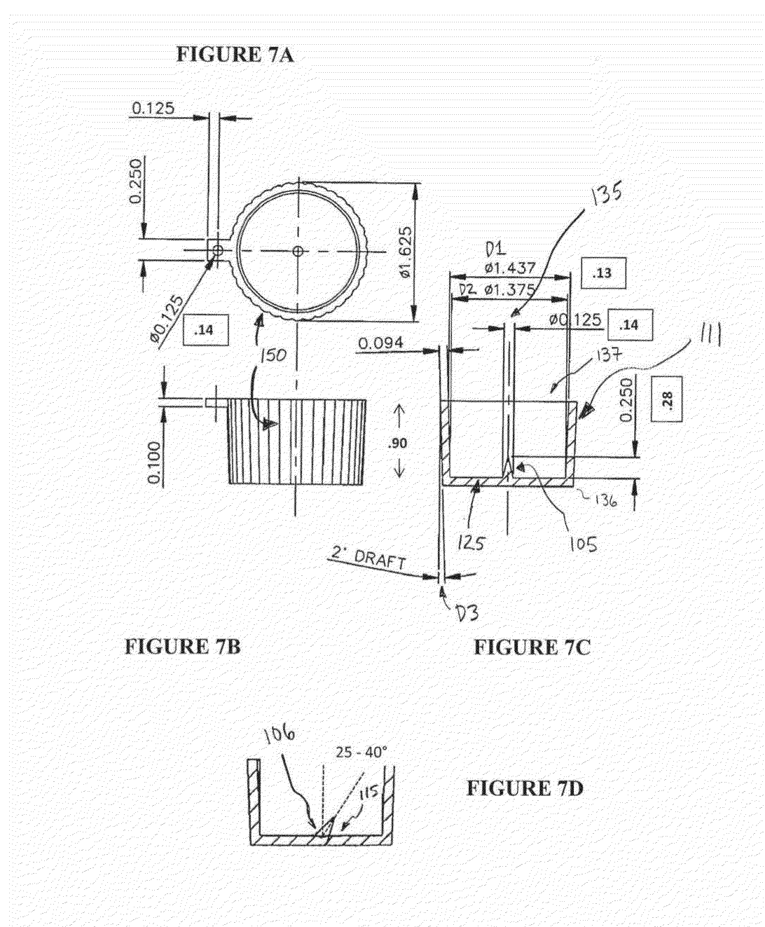

FIGS. 1A and 7A show bottom views of an integral point cap opener tool 100, while FIGS. 1B and 7B show side views of the opener tool 100, and FIGS. 1C and 7C show cross sectional views. FIGS. 1D and 7D show another example embodiment of an opener tool employing an oblique angled needle 106 offset with respect to the plane of the base/ceiling 115 of the housing 125. FIGS. 1A-1D and 7A-7D show housing 125 as a substantially cylindrical element closed at a first end 136 and open at a second end 137.

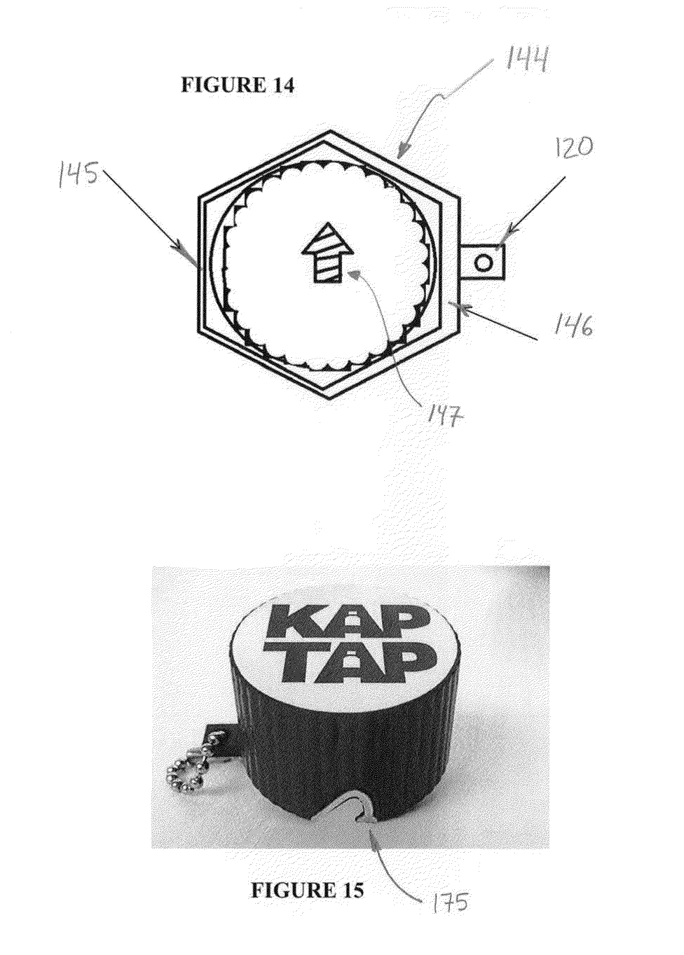

As shown in the figures (especially in FIGS. 1A-1C and 7A-7C), sidewall 110 of housing 125 of the integral point cap opener 100 can be made of various thicknesses. Some embodiments use a thicker sidewall to provide improved durability while other example embodiments use a thinner sidewall such that sidewall 110 can be inserted between a pop top opener on a soda (or other) can and used as a fulcrum to open the pop top (not shown separately). For example, in FIGS. 7A-7D, sidewall 110 is 0.094 inches thick, while in FIG. 14, sidewalk 145, 146 are different thicknesses.

As shown in the example embodiments of FIGS. 1A-1D and 7A-7D, sidewall 111 can be angled such that the portion of sidewall 111 at the open end 137 of housing 125 extends outward with respect to the center axis 135 of housing 125. For example, the diametric distance D1 at the open end 137 of housing 125 can be larger than the diametric distance D2 at the closed end 136 of housing 125. In one example embodiment, the diametric distance D1 is 1.437 inches, and the diametric distance D2 is 1.375 inches. These relative distances can be changed to accommodate a wide array of bottle tops and caps. The outward angled sidewall 111 facilitates positioning of the tool 100 over bottle tops and caps as the tool 100 receives the bottle or other container.

In addition to angled sidewall 111, a draft angle D3 can be used to further facilitate positioning of the tool 100 over bottle tops and caps. Draft angle D3 shows the angle of the angled sidewall 111 from a vertical axis of the base 115 of the housing 125. In one example embodiment, the draft angle D3 is 2 degrees from vertical as shown in FIG. 7C, In this same example embodiment, the angled needle 105 can be about 0.25 inches tall with a base diameter of 0.125 inches. In this example, the angled needle 105 is essentially shaped as a cone attached to or formed in the base 115 of the housing 125.

The sidewall 110, base 115, top 112, and angled needle 105 can be modified based on the desired use of the tool 100. The thickness of the walls can be varied, as the angled needle 105 can be used on many different bottle tops. The size of the housing 125 can also be modified to provide an array of diametric distances. Similarly, the height of the sidewall can be increased or decreased to fit the desired use. For example, an opener tool of the claimed invention can be used on screw cap water bottle tops, aluminum cans with tab tops, scalloped metal beer bottles, soda, juice, water, and liquid tops, as well as other bottle tops.

Additionally, as shown in the example embodiments of FIGS. 1D and 7D, the angled needle 106 can point vertically downward at an angle other than 90 degrees from the base/ceiling 115 of the housing 125. That is, the angled needle 106 can be oblique to the base 115 of the housing 125. For example, FIGS. 1D and 7D, the angled needle 106 can point between 25 degrees and 40 degrees from vertical, such as an example angle of 30 degrees shown in FIG. 7D. When used to penetrate a beverage cap, the angled needle 106 provides an angled cut in the beverage cap, which prevents spillage of the beverage through the cap hole. The angled needle 106 is shown approximately in the center of the base 115 of the housing 125 of the opener tool 100 and penetrates plastic and other bottle caps to access beverages or other liquid products in the bottles. However, the angled needle can be offset from the center of the base/ceiling 115 depending upon the desired use of the tool and the caps upon which the tool will be used.

Bottle tops can be of many sizes and shapes, and the actual and relative dimensions of the tool can be varied to accommodate the different sizes and shapes. In each case, the opener tool of the claimed invention provides an easy method of opening sealed bottle tops.

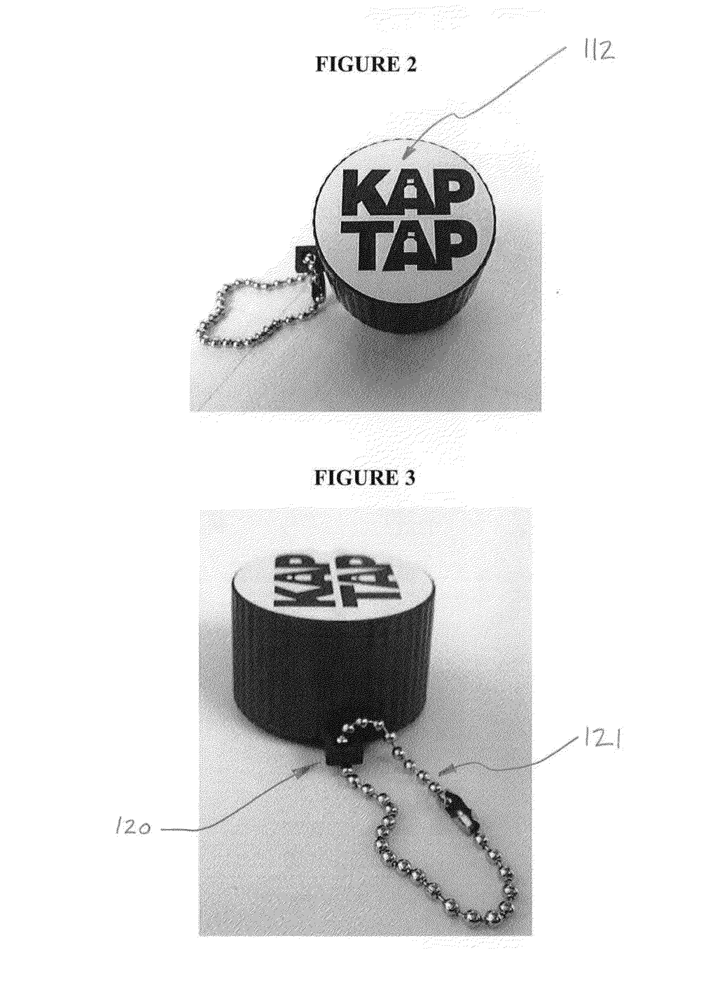

As shown in the top and side views of FIGS. 2 and 3, one embodiment of an opener tool in accordance with the claimed invention includes atop surface 112 that can be custom labeled. The top surface can include ornamental designs or other symbols, textures, and the like, such as brand names, logos, team names, promotional messages, and the like.

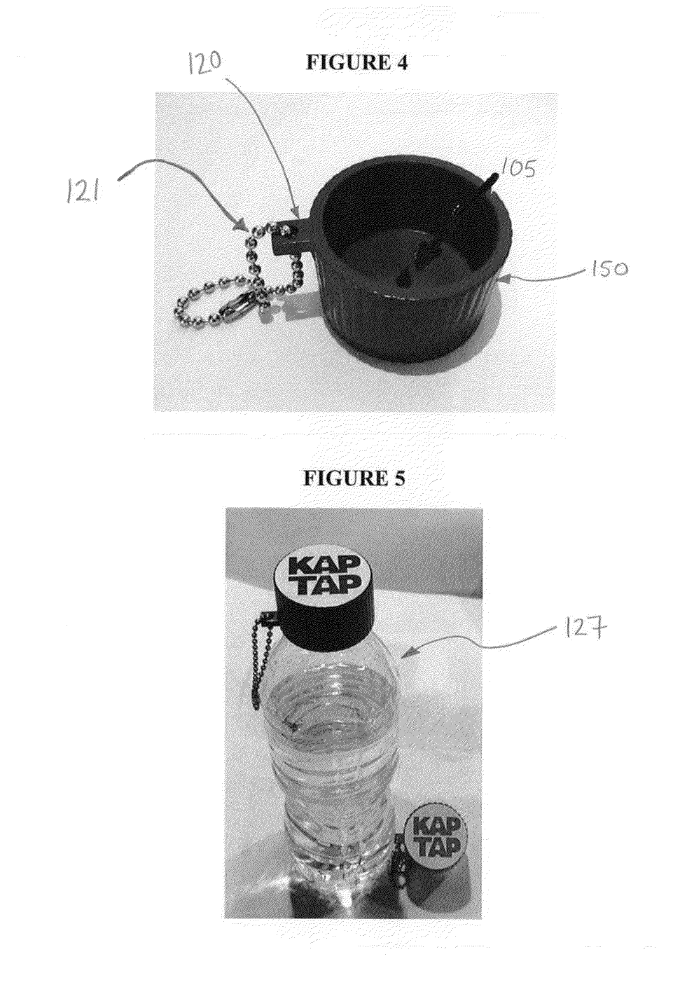

Additionally, as shown in FIG. 3, the opener tool 100 can include an optional tab 120, and a chain, ring, string, or other tether device 121 can be inserted or otherwise attached to carry the opener tool 100, to secure it, or to facilitate locating the opener tool 100. FIG. 4 shows a bottom view of an example embodiment of an opener tool 100 in accordance with the claimed invention, including a tab 120 where a chain 121 is attached to carry the tool 100. The angled needle 105 is shown extending from the base 115 on the bottom side of the housing 125 of the opener tool 100.

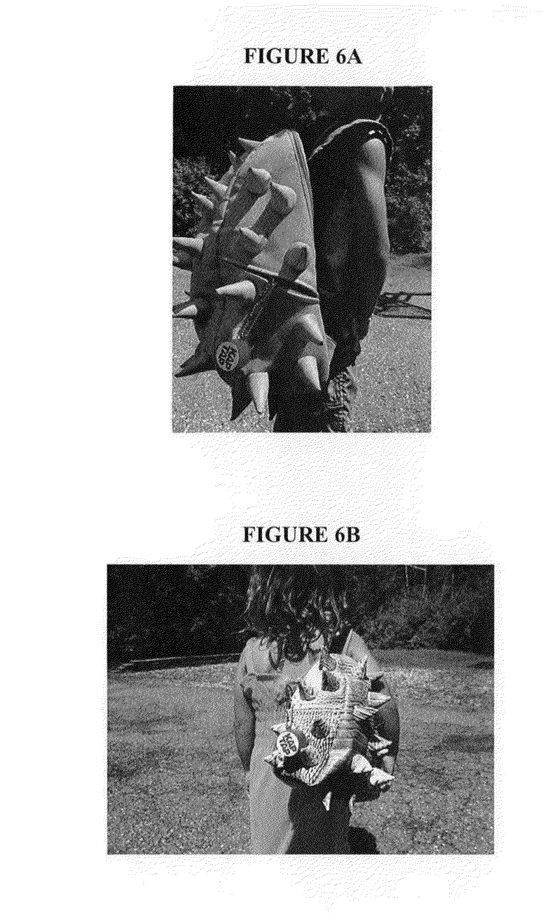

FIGS. 6A and 6B show examples of users carrying the opener tool 100. As also shown in the Figures, the housing 125 of the tool 100, including the sidewalls 110, can include ribs 150 or other textured features to provide an easy grip surface with which a user can operate the integral point cap opener tool 100. See FIG. 1A and FIG. 4, for example. Likewise, the tool can include an enlarged grip surface (not shown separately), such as a concentric handle area or an offset portion with which the user can operate the tool. For example, using an enlarged grip surface, or a concentric handle area, or an offset portion of the tool, a user can gain additional mechanical advantage with greater torque to operate the tool.

Further, the opener tool can be formed in non-circular shapes, such as ovals, hexagons, octagons, and the like, to facilitate use by children, the elderly, and those that may have difficulty with twist-off caps or other small shapes. As shown in one example embodiment in FIG. 14, a non-circular housing, such as a hexagonal cross section housing 144, can be used in the opener tool to facilitate easy opening for younger consumers, older consumers, and any other users that may experience difficulty using twist-off caps or small devices. Additionally, an oval cross section can be used in the opener tool to replace other bottle openers that are used to open bottles with non-twist off caps. Likewise, a scalloped circle or an enlarged tool (shown in FIG. 5) can be used to provide additional leverage and rotation force to the bottle cap.

As outlined above with regard to a generally cylindrical opener tool, the sidewalls, base, top, and angled needle of non-cylindrical opener tools can also be modified based on the manner in which the tool will be used. As shown in FIG. 14, the wall 145 opposite tab 120 can be designed and manufactured to be thinner than the wall 146 on which tab 120 is formed. For example, wall 145 can be manufactured to be 0.050 inches and wall 146 can be manufactured to be 0.094 inches. This relatively thinner wall 145 can then be used pry a pop-top up from a beverage can, such as a soda can, beer can, and the like.

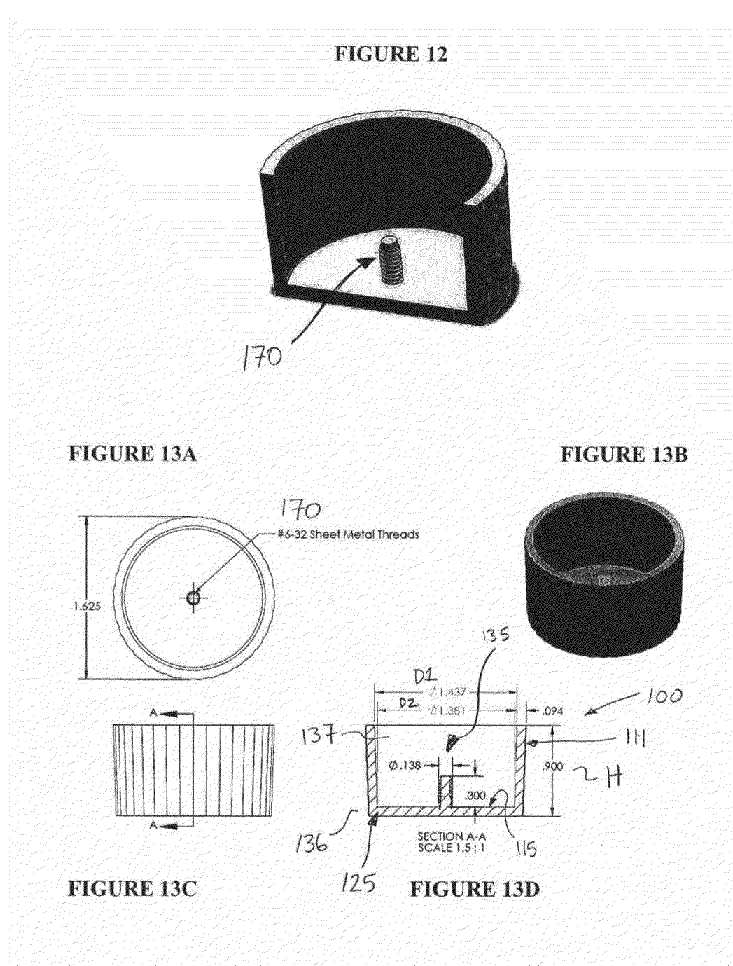

FIG. 14 also shows a non-conical angled needle 147 that can be used to puncture plastic bottle caps. Further, as shown in FIGS. 12-13, in one example embodiment, the claimed invention can employ a screw thread 170 as a part of or in place of the angled needle to puncture and penetrate plastic bottle caps. FIGS. 13A-13D, respectively, show a bottom view of an opener tool, a bottom perspective view, a side view, and a cross section view. The angled needle with the screw thread 170 is shown approximately in the center of the base 115 of the opener tool 100 and penetrates plastic and other bottle caps to access beverages or other liquid products in the bottles. In one example embodiment, screw thread 170 can be 0.138 inches in diameter and extend 0.3 inches vertically from the base 115 of the housing 125. Other screw dimension sizes for screw thread 170 can be used, such as #6-32, 8-32, 10-24, and the like. An opener tool using the screw thread 170 can be rotated into a plastic bottle cap to puncture the bottle cap. The screw thread 170 can also be used to reseal the plastic bottle after a user accesses the liquid through the cap hole.

As further shown in FIGS. 13A-13D, the relative size and dimensions of the tool 100 can accommodate a number of different angled needles, including screw thread 170. For example, the sidewall 111 of the housing 125 that includes screw thread 170 can be angled as outlined above with regard to the angled needle 105 and the oblique offset angled needle 106 such that the portion of sidewall 111 at the open end 137 of housing 125 extends outward with respect to the center axis 135 of housing 125. As was the case with the angled needles 105 and oblique offset angled needle 106, the diametric distance D1 at the open end 137 of housing 125 can be larger than the diametric distance D2 at the closed end 136 of housing 125, In the example embodiment shown in FIG. 13D, the diametric distance D1 is 1.437 inches, and the diametric distance D2 is 1.375 inches. These relative distances can be changed to accommodate a wide array of bottle tops and caps regardless of the type of needles used. The outward angled sidewall 111 facilitates positioning of the tool 100 over bottle tops and caps as the tool 100 receives the bottle or other container.

The opener tool can also include other opening devices, such as bottle openers and the like. For example, FIG. 15 shows an example side view of an opener toot in accordance with the claimed invention incorporating an integrated bottle opener 175.

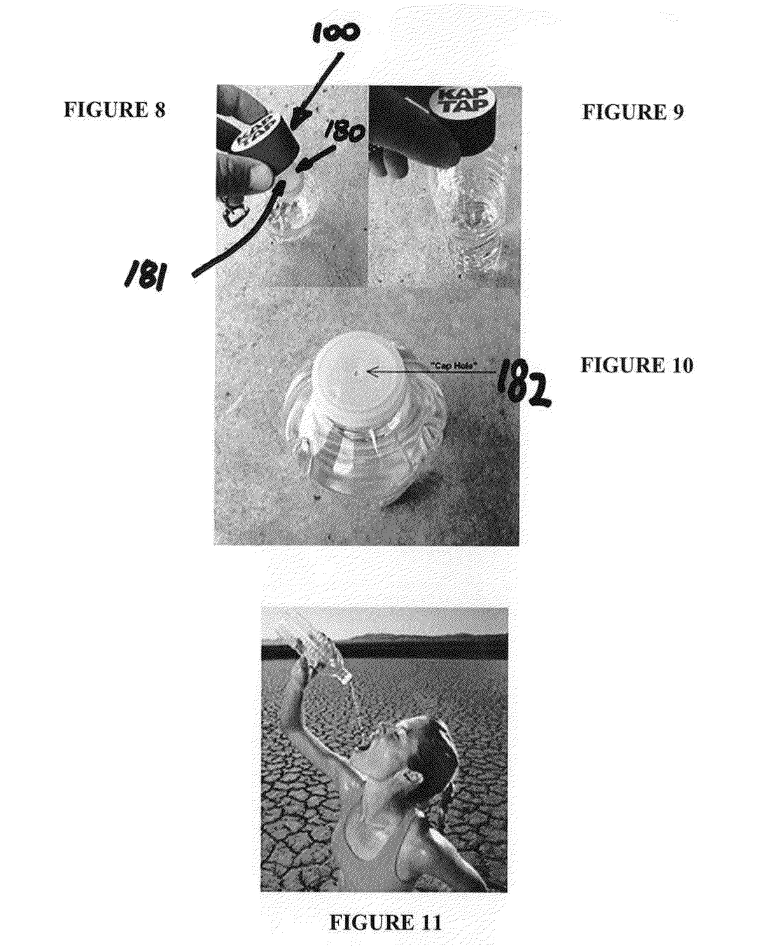

As shown in FIGS. 8 and 9, in use, a user places an opener tool 100 over a plastic bottle cap 180 with the angled needle (shown in other Figures) against the top 181 of the cap and applies a (downward) force to the opener tool 100 to puncture the cap 180 of the plastic bottle. The user removes the opener tool 100 from the plastic bottle cap 180. The angled needle punctures the bottle cap 180, forming an angled cut (cap hole 182) as shown in FIG. 10. As outlined above with regard to FIGS. 1, 4, 7, 12, 13, and 14, the angled walls of the angled needle form a corresponding angle in the cross-section of the bottle cap 180 as the bottle cap 180 is penetrated. The resulting cap hole 182 provides access to the liquid product in the bottle, while the angled cut of the cap hole 182 prevents spillage of the liquid from the bottle.

Once the cap hole 182 is formed, the user can then access the liquid in the bottle by applying pressure to the bottle by squeezing the bottle, by rotating the bottle so the cap hole is lower than the level of the liquid, or by otherwise pouring liquid from the bottle via the cap hole as shown in FIG. 11. The angled cut of the cap hole 182 prevents spillage of the beverage through the cap hole 182. The integral point cap opener 100 provides users with easy access to the beverage without having to worry about a major mess or waste of product if the bottle is knocked over.

The opener tool of the claimed invention provides a convenient and reusable method of opening plastic bottle tops prior to consuming the beverage or liquid. There is no need for sports bottle caps as the opener tool opens plastic bottles without the need to disassemble a sports bottle, open a sealed foil layer, discard the sealed foil layer, and reinstall the sports bottle cap before the liquid can be dispensed. The opener tool of the claimed invention eliminates the chance for injury as no additional tools are needed to open a sealed foil layer, since the sealed foil layer can be eliminated. The opener tool provides users an efficient manner of consuming the beverage without waste or spillage. The claimed invention can include child-safe, travel-safe and environmentally-safe features.

We claim:

1. A cap opener tool comprising:
a housing configured to fit over a cap of a container, the housing including
a top surface;
a sidewall; and
a base; and
an angled needle extending vertically from the base of the housing.

2. A cap opener tool of claim 1, wherein the sidewall is substantially a cylindrical wall and the base is substantially a circular base, and the cylindrical wall is attached substantially perpendicularly to the circular base.

3. A cap opener tool of claim 2, wherein the sidewall extends outward with respect to a center axis of the base of the housing.

4. A cap opener tool of claim 3, wherein the sidewall includes a draft angle with respect to the center axis of the base of the housing.

5. A cap opener tool of claim 1, wherein the angled needle is substantially conical.

6. A cap opener tool of claim 5, wherein the angled needle is substantially a right cone.

7. A cap opener tool of claim 5, wherein the angled needle is substantially an oblique cone.

8. A cap opener tool of claim 7, wherein a vertex of the angled needle is positioned at an angle between 25 and 40 degrees from vertical with respect to the base.

9. A cap opener tool of claim 1, wherein the angled needle is substantially frustoconical.

10. A cap opener tool of claim 1, wherein the angled needle includes a screw thread mounted to the base of the housing.

11. A cap opener tool of claim 10, wherein the base is substantially circular.

12. A cap opener tool of claim 11, wherein the screw thread is mounted substantially in the center of the circular base.

13. A cap opener tool of claim 1 further comprising:
a tab configured to receive a carrying tether.

14. A cap opener tool of claim 13 further comprising:
a carrying tether.

15. A cap opener tool of claim 1, wherein the housing includes a textured grip surface.

16. A cap opener tool of claim 1 further comprising:
at least one of a concentric handle grip assist and an offset handle grip assist.
